(19) United States
(12) Patent Application Publication
(10) Pub. No.: US 2025/0132521 A1
(43) Pub. Date: Apr. 24, 2025

(54) POWER PACK FOR A BACKPACK VACUUM AND THE LIKE

(71) Applicant: Scott GENOA, Woodbury (CA)

(72) Inventor: Scott GENOA, Woodbury (CA)

(21) Appl. No.: 18/923,001

(22) Filed: Oct. 22, 2024

Related U.S. Application Data
(60) Provisional application No. 63/592,565, filed on Oct. 23, 2023.
(60) Provisional application No. 63/596,252, filed on Nov. 4, 2023.

(51) Int. Cl. H01R 13/58; A47L 5/36; A47L 9/28; H01R 13/44; H01R 13/506; H01R 13/639; H01R 24/30; H01R 105/00

(52) U.S. Cl. CPC H01R 13/5812; A47L 9/2868; H01R 13/44; H01R 13/506; H01R 13/639; H01R 24/30; A47L 5/36; H01R 2105/00

(57) ABSTRACT

A power box for use with a vacuum cleaning unit adapted to be carried on the back of a user is structurally arranged so as to be transportable with the user and comprising an external housing including a recessed power receptacle for receiving a power cord, a separate coupler threaded with the recessed power receptacle for securing power cords of differing plug dimensions. Further comprising recessed structures for receiving a power cord for an auxiliary device for use with the vacuum cleaning unit and connector structures adapted to secure the power cord in a manner to be released.

### CROSS-REFERENCE TO RELATED APPLICATIONS

This application claims the benefit of U.S. Provisional Application Ser. No. 63/592,565 filed Oct. 23, 2023, and of U.S. Provisional Application Ser. No. 63/596,252 filed Nov. 4, 2023. The disclosures, drawings and descriptions thereof are hereby incorporated by this reference.

### FIELD OF THE INVENTION

The present invention related to a power pack suitable for use for a vacuum cleaner configured as a backpack, or similar item, needing secure connections for power cords that will not be dislodged easily or unexpectedly. In particular, the present invention involves a receptacle for the power cords for a mobile device such as a backpack vacuum cleaner providing a secure anchors for the main power cord and also a quick disconnect for the power cord for an auxiliary device, such as, for example, a power wand typically used with backpack vacuums.

The assignee of the present inventor refers to its prior patent, U.S. Pat. No. 9,742,093, and incorporates the disclosure thereof and references cited. The power pack of the present invention is an improvement of the prior invention by enabling the power cords to be more securely held in place. The present invention also provides a secure indication of an automatic shut off in the event the bag receiving vacuumed contents becomes too fill in order to allow suction to operate efficiently. Also, the power pack of the present invention can be remote controlled.

### SUMMARY OF THE INVENTION

The power pack for a multi-piece mobile device, such as a backpack vacuum, includes recessed receptacles for the power cord connections and includes structures providing secured connection for holding the main power cord firmly in place, and a connection for an auxiliary power cord that provides a secure connection but yet a quick release capability for powering an accessory such as an optional power wand or nozzle extension. And the controls sense the suction power so that a diminished suction capacity indicating the vacuum-contents bag is near filled to provide a signal to the operator to disrupt the power to protect the motor and other elements of the device, or shut off the power if needed.

As shown in the drawings and described in detail below, according to the present invention, a power box is provided with a recessed 3-prong male receiving outlet, a recessed female receptacle for an optional power nozzle hookup, a push button on-off switch that can be remote controlled for controlling the power to the backpack vacuum; all conveniently located with secure connections to hold the power cords securely in place. Further, the on/off power switch also has an illuminating portion to provide a signal when the air flow of the vacuum is reduced indicating the storage bag for the vacuumed materials of the vacuum cleaner is becoming too full to operate efficiently.

### BRIEF DESCRIPTION OF THE DRAWINGS

FIG. 1 is a perspective view of the power box of the present invention in assembled condition;

FIG. 2 is a view of the power cord coupler;

FIGS. 3A through 3E are detailed views of the power cord coupler;

FIG. 4 is a perspective view of the power box of the present invention with the power cord coupler removed;

FIG. 5 illustrates the plug end for the power cord for optional equipment between its clamshell connectors;

FIG. 6 illustrates the plug end for the power cord for optional equipment partially assembled with its clamshell connectors;

FIG. 7 illustrates the plug end for the power cord for optional equipment assembled with its clamshell connectors;

FIG. 8 is a circuit diagram explaining the electronics for the sensing of suction power and power indication and control.

### DETAILED DESCRIPTION OF THE INVENTION WITH REFERENCE TO THE DRAWINGS

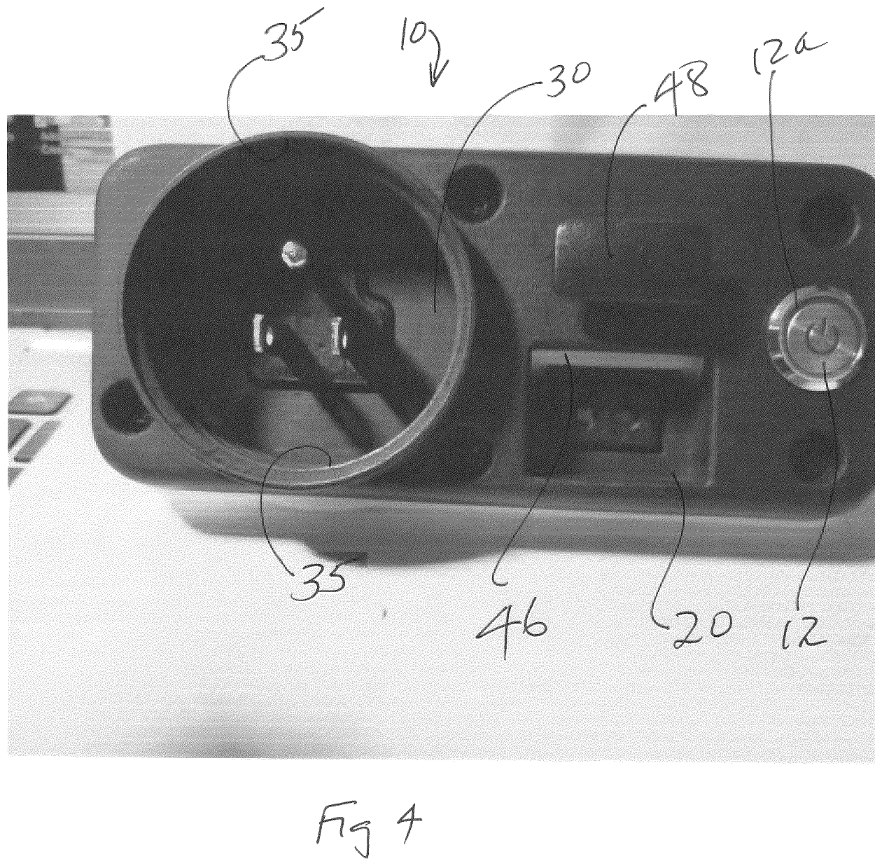

As shown in FIG. 4, a power box 10 for a backpack vacuum or the like comprises a recessed power receptacle 30 and recessed auxiliary power hookup 20. The power receptacle 30 comprises a male 3-prong attachment for receiving the female end of the main power cord; and the power hookup 20 comprises twin female receptacles for attaching a power cord for an optional power nozzle or other auxiliary equipment.

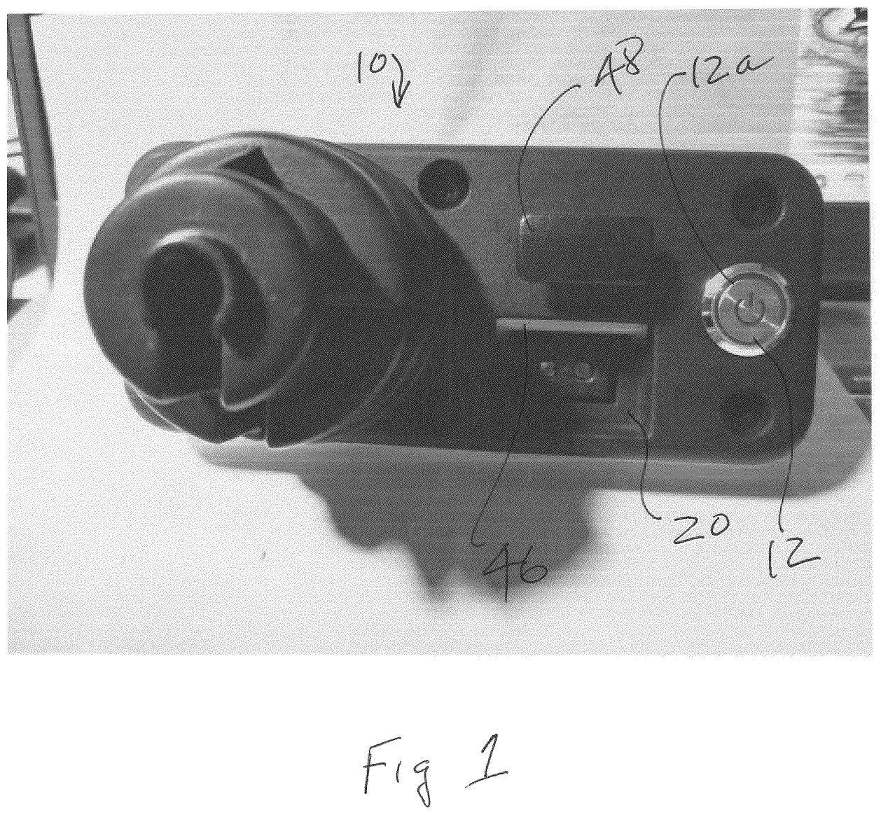

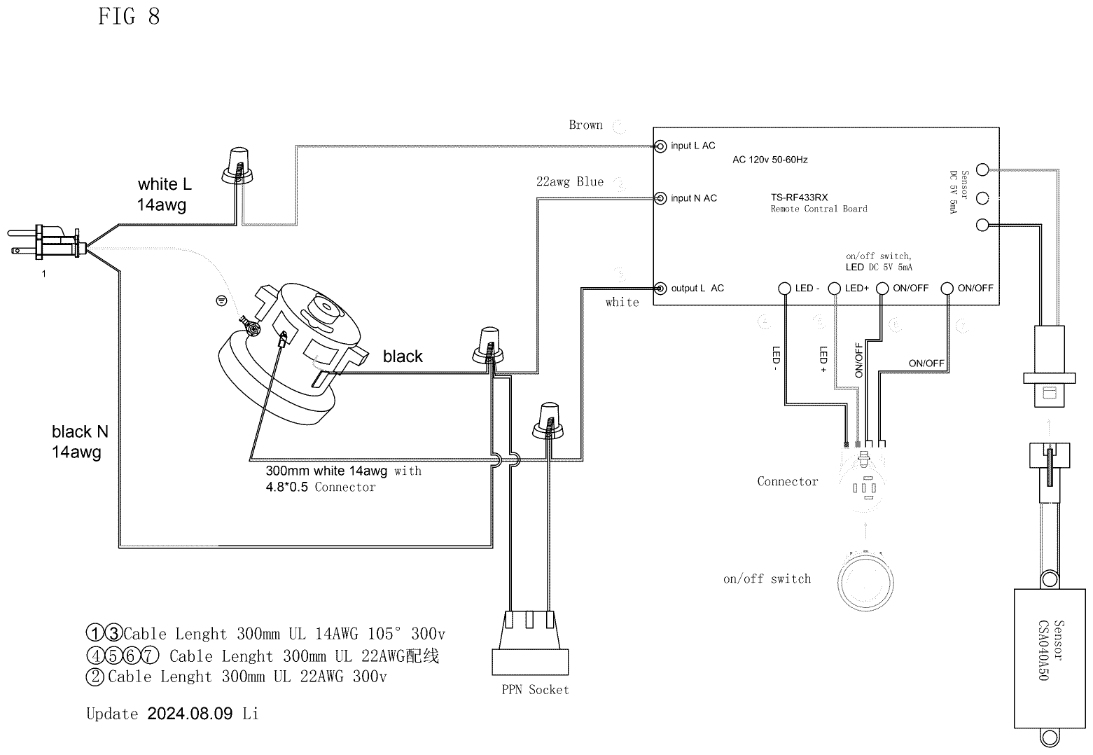

In a typical backpack vacuum, a small power box is provided, perhaps fitted at or near the waist of the user when the backpack vacuum is being worn for use; or fixed to the canister of the pack back vacuum. The power box is generally provided for easy access by the user to the controls. The present invention includes an on/off power switch 12 illustrated in FIG. 1. Power switch 12 is preferably a push button, and has an illuminating ring 12a indicating the power is “on” for the vacuum. The power switch 12 may be accessed by a remote unit which may be stored in a pouch fixed to the backpack unit's straps or the unit itself at a location for easy access by the user. In preferred form, the illuminating ring 12a flashes when the air flow of the vacuum is reduced indicating the contents bag of the vacuum cleaner is becoming too full to operate efficiently. The electronics to acuate the switch 12 and illuminating ring 12a are shown in FIG. 8.

The present invention maximizes the efficiency of the power box 10 by providing a multi-functional power box, with not only easy access to controls, but secure connections for the power cords.

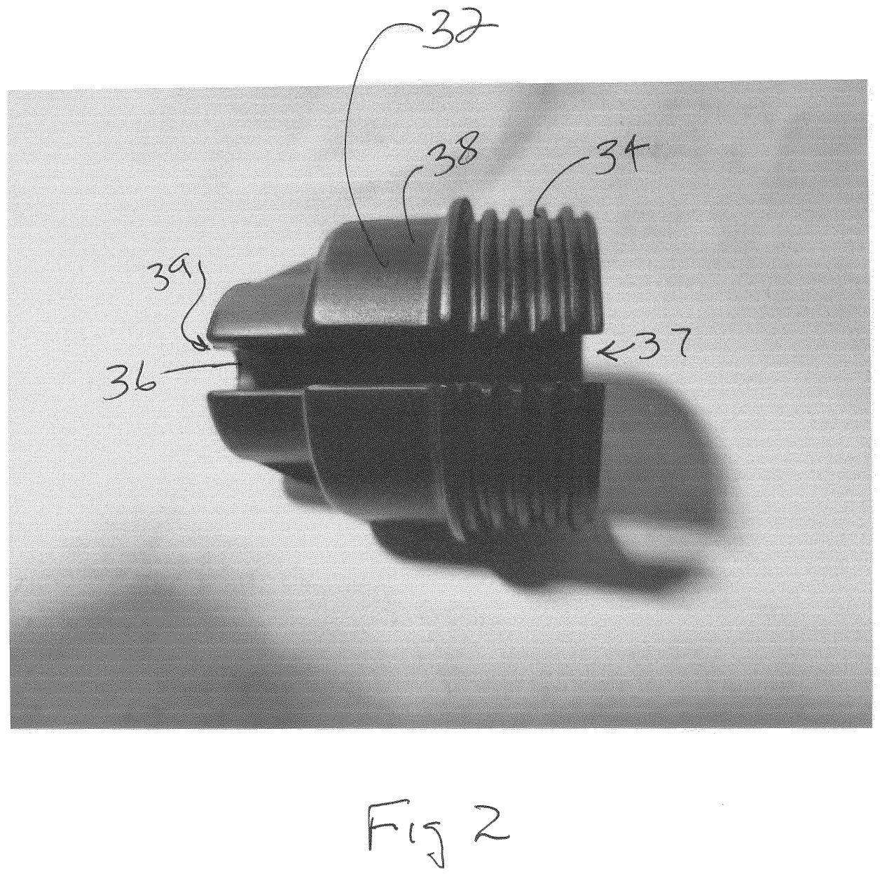

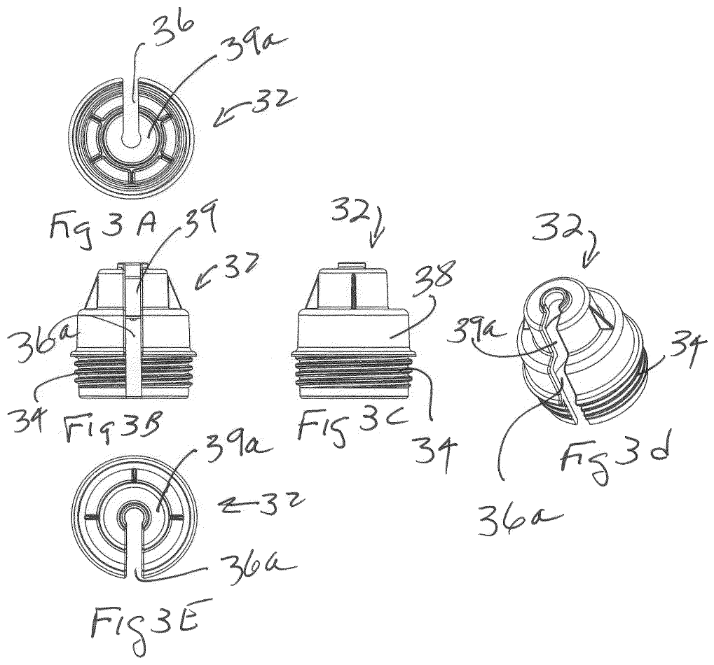

FIG. 2 and FIGS. 3A through 3E illustrate a coupler 32 having external threads 34 enabling the coupler 32 to be screwed into recessed power receptacle 30 having matching internal threads 35. The coupler 32 can receive the 3-pronged power cord through longitudinal opening 36. Coupler 32 has an enlarged portion 38 that is relatively thin-walled to provide a large diameter portion 37 of longitudinal opening 36; and a smaller portion 39 that has a thicker wall 39a to provide a much narrow portion 39 for longitudinal opening 36. FIG. 3A illustrates the holder 32 looking into the enlarged portion 38, and FIG. 3E illustrates the holder 32 looking into the smaller portion 39 of the coupler 32.

The longitudinal opening 36 is formed by slot 36a on the outside wall of coupler 32 and enables the power cord and its female plug to be inserted into coupler 32 with the plug in the enlarged portion 38 to be plugged into the 3-pronged attachment and the coupler threaded into the recessed power receptacle 30 until the wall 39a engages the outer back end surface of the female plug to firmly secure it into the 3-pronged attachment. In this way, power cords having female plugs of varying dimensions can be secured by the coupler 32 by rotating the threaded coupler into the recessed power receptacle as necessary to firmly engage the outer back end surface of the female plug.

This structure allows varying styles of 3-prong power or extension cord to be used with the present invention, allowing versatile use in multiple settings, and where any number of lengths and style of power cords can be used. In some settings a very long cord (25-50 ft, and up) may be needed, and in others a cord that is only a few feet long is needed. By these structures, the shielded and recessed power receptacle 30 with the secure locking coupler 32 threading into the recessed power receptacle 30 provides a very secure connection for a variety of power cords, that will not come undone easily while operating the machine regardless of the path the user may take providing variable tension to the power cord.

Most backpack vacuums also come with an optional hookup for a power nozzle or other accessory. Such other accessories allow a backpack vacuum configured to have an optional hookup to be more versatile allowing attachment of a variety of extenders and attachments. This enables the backpack vacuum to be able to function more like a standard, multi-function upright or canister vacuum.

The recessed power hookup 20 is also protected by a recessed cavity to allow a secure hookup that will not come undone easily while operating the machine, and allows for quick easy access and adaptation of the backpack for a variety of settings.

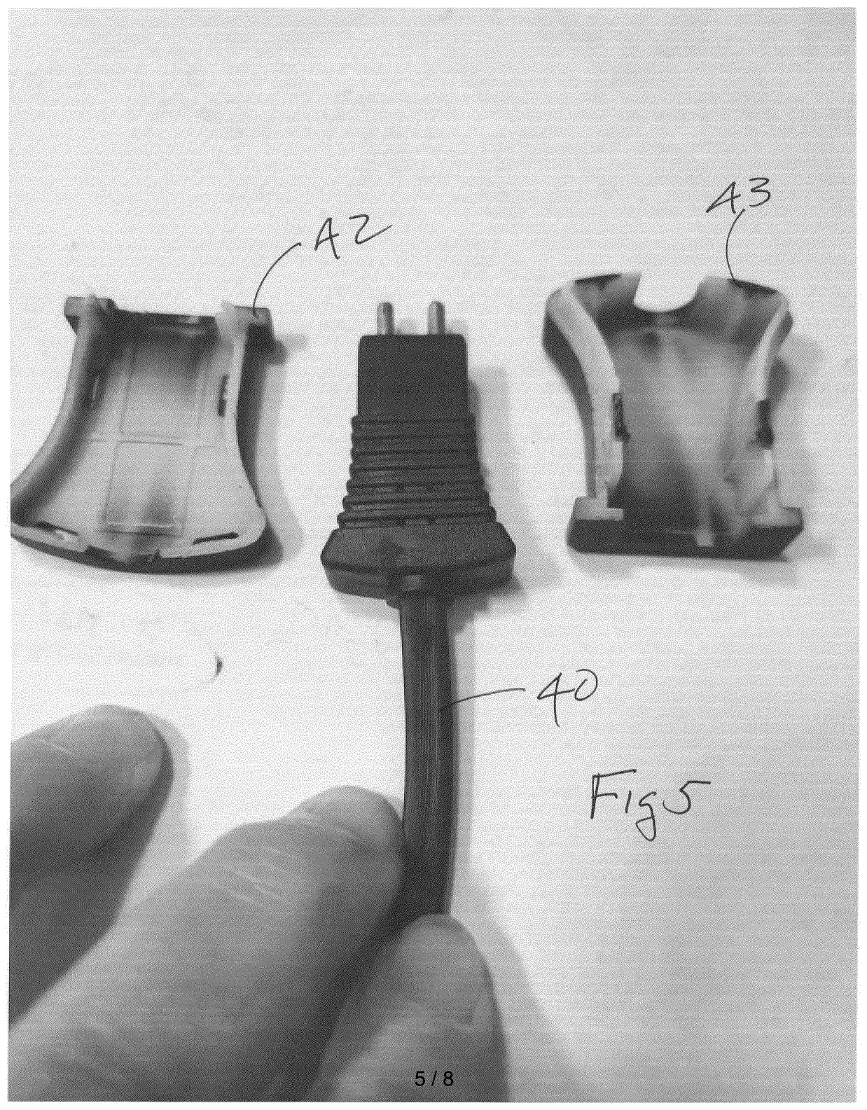

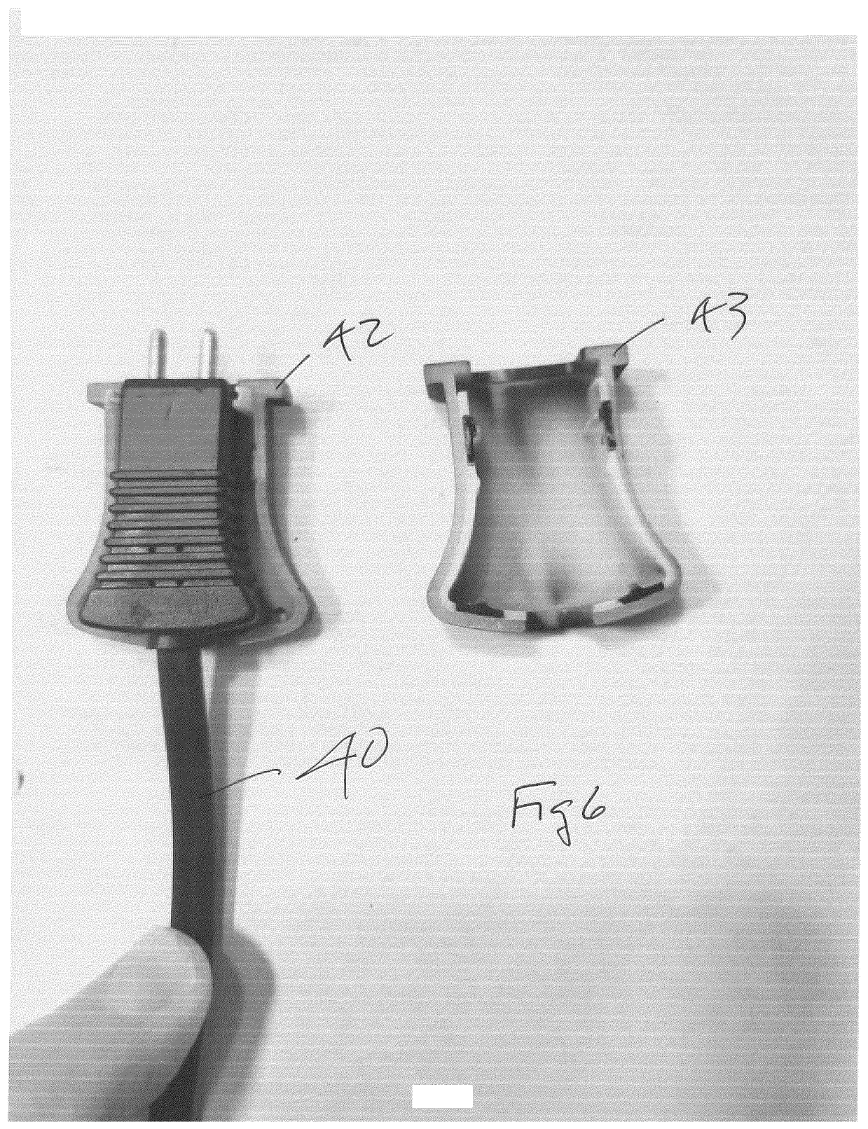

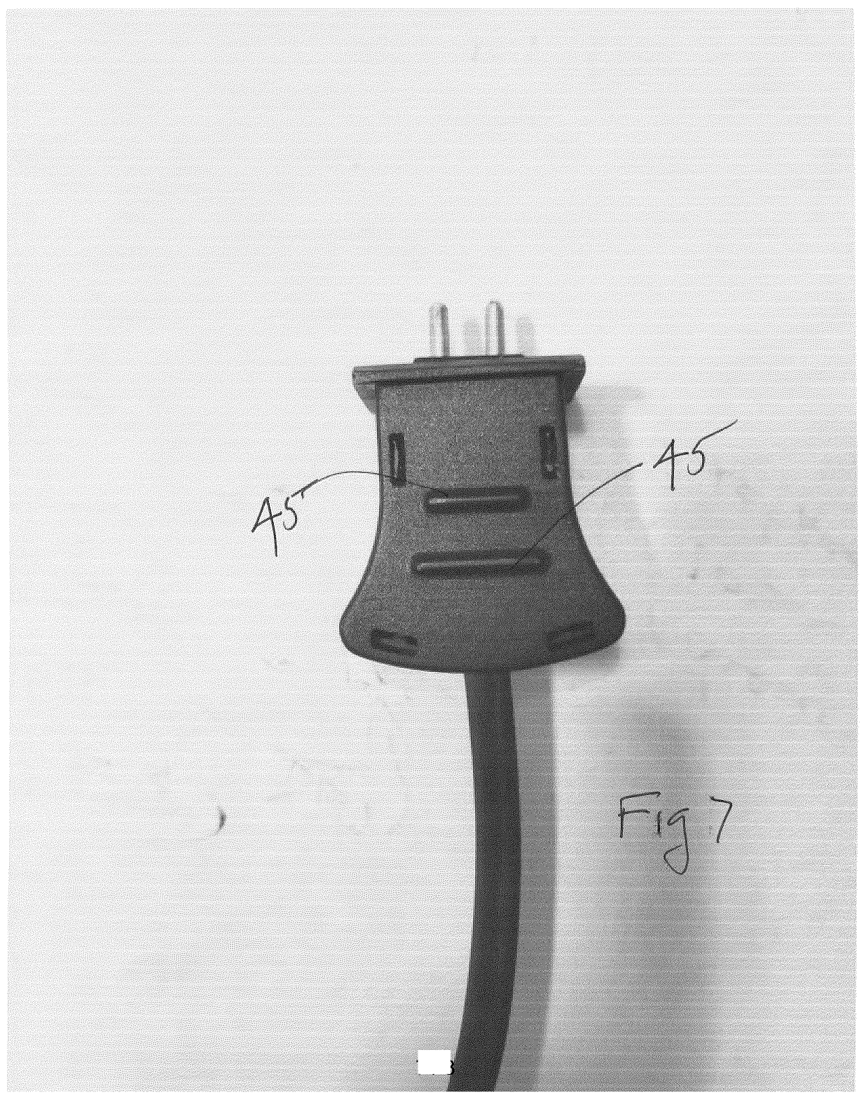

Another feature of the present invention is the provision of a clamshell protection for a secure connection for a power cord of an auxiliary device. The power cord 40 for such an auxiliary device as a power nozzle has male prongs for insertion into recessed power hookup 20, and clamshell connectors 42 and 43 that may be snapped together as shown in FIGS. 5, 6 and 7.

The outer surface of the clamshell connectors 42 and 43 have upstanding ridges 45 that engage retractable lever 46 in the opening of the recessed power hookup 20 to securely grip and hold the power cord 40 when pushed into position in the recessed power hookup 20. Push button 48 can be actuated by the operator to lift the retractable lever 46 to disengage from the upstanding ridges 45 to release the auxiliary power cord when desired. In this way, the auxiliary power cord is secured held in position until released by the operator.

The electrical circuitry for the power switch and indicator for the bag contents is illustrated in FIG. 8. The circuitry of FIG. 8 uses a sensor to sense the extend of vacuum being created to provide a warning by flashing light of a need to empty of change the contents of the storage bag.

1. A power box for use with a vacuum cleaning unit adapted to be carried on the back of a user, said power box structurally arranged so as to be transportable with the user and comprising an external housing including a recessed power receptacle for receiving a power cord, a separate coupler for receiving the power cord and adapted to be connected removably to said recessed power receptacle for securing said power cord during movements of the user.

2. A power box for use with a vacuum cleaning unit as set forth in claim 1, said power box further comprising recessed structures for receiving a power cord for an auxiliary device for use with said vacuum cleaning unit, connector structures adapted to be secured to the end portion of the power cord for an auxiliary device, said recessed structures including a receiver for said connector structures connected to hold the end portion of the power cord for an auxiliary device in said recessed structures in a manner enabling the user to release the end portion of the power cord for an auxiliary device.

3. A power box for use with a vacuum cleaning unit as set forth in claim 2, said connector structures being two halves of a clamshell housing fitting securely to the end portion of the power cord for an auxiliary device and securely within said recessed structures.

4. A power box for use with a vacuum cleaning unit as set forth in claim 3, said clamshell housing having upstanding ridges to fit within recesses in said recessed structures, and a lever actuated by the user to disengage said ridges.

5. A power box for use with a vacuum cleaning unit as set forth in claim 1, said separate coupler having a portion adapted to engage the back end of the plug for the power cord, and said separate coupler and said recessed power receptacle having mating threaded portions to selectively engage the back end of the plug for the power cord of varying dimensions.
